(19) United States
(12) Patent Application Publication
(10) Pub. No.: US 2003/0105555 A1
(43) Pub. Date: Jun. 5, 2003

(54) Method of issuing medical supplies and dispensing and administering medications through a hand-held device and a device and system for doing the same

(76) Inventors: Richard R. Lunak, Pittsburgh, PA (US); Mary Elizabeth Navarra, Allison Park, PA (US); Philip H. Spano JR., McKees Rocks, PA (US); Cary S. Piotrowski, Sandy, UT (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/998,121

(22) Filed: Nov. 30, 2001

(51) Int. Cl. G06F 17/00

(52) U.S. Cl. 700/237

(57) ABSTRACT

A method and apparatus for dispensing and administering medications and issuing medical/surgical supplies using a device communicating with a central database is comprised of the steps of: (a) inputting information about a patient to the device for whom at least one medication may be dispensed and administered; (b) dispensing the at least one medication to the patient by inputting information about the at least one medication to the device; (c) saving the at least one medication to the patient selected; (d) inputting information about a patient to the device for whom at least one medical/surgical supply may be issued; (e) issuing the at least one medical/surgical supply to the patient by inputting information about the at least one medical/surgical supply to the device; and (f) saving the at least one medical/surgical supply to the patient selected. The method may be integrated into various other methods such as methods of restocking.

### TECHNICAL FIELD

The invention relates to a device and system for issuing medical supplies, dispensing and administering medications, and tracking supply inventory. More specifically, the present invention relates to a system for: issuing of medical supplies; dispensing and administering of medications; and tracking, inventory maintenance, billing and restocking of medications and medical supplies, using a real-time hand-held device communicating with a central or core database.

### BACKGROUND OF THE INVENTION

Providing quality patient care in hospital and medical facilities requires the accurate issuance of medical supplies, and dispensing and administering of medications to the patients. Currently, separate and distinct departments manage these functions. Specifically, the pharmacy is responsible for the dispensing, tracking, inventory maintenance and billing and restocking of medications while the materials management is responsible for the issuing, tracking, inventory maintenance and billing and restocking of medical/surgical supplies. Nursing personnel are responsible for administering medications and utilizing medical/surgical supplies.

Much progress has been made in each of these departments to more accurately and efficiently manage their functions. It has been known in medical facilities, such as hospitals, nursing homes, etc. to have a centralized location such as a pharmacy department within the facility to coordinate the dispensing inventory management and tracking of medications to the patients of the medical facility. A very important function of the centralized pharmacy is to restock various decentralized locations, e.g. nurse stations, decentralized medication rooms, unit based cabinets, etc., with the quantity and types of medications that must be dispensed and administered from the decentralized locations on a daily basis. The storage of medications at various decentralized locations within the hospital allows the caregivers, such as doctors, nurses and other healthcare workers (i.e. Respiratory therapy, nursing aids and assistants) with the appropriate security clearance, to access, dispense and administer medications in a more efficient manner. Additionally, the pharmacy is responsible for the complex record keeping and inventory management of the medications. The pharmacy is responsible for the tracking, inventory management and billing and restocking the medications within the medical facility.

Likewise, in many hospitals and facilities the centralized materials management has set up decentralized storage locations on each floor in the hospital or within each department to provide access to caregivers to the medical/surgical supplies needed. The caregiver with the appropriate security clearance can obtain medical/surgical supplies for issuance in a more timely and efficient manner. Additionally, the materials management is responsible for the complex record keeping and inventory management of medical/surgical supplies. The materials management is responsible for the tracking, inventory management and billing and restocking the medical/surgical supplies within the medical facility.

Various methods have been employed to assist the centralized pharmacy with maintaining accurate records while attempting to reduce the burden of managing all of the information associated with the dispensing and administration of medications. Likewise, various methods have been employed to assist the centralized materials management with maintaining accurate records while attempting to reduce the burden of managing all of the information associated with the issuing of medical/surgical supplies. However, while both the pharmacy and the materials management have made improvements to automate many of their functions, they still operate as separate and distinct departments. More specifically, caregivers must use separate systems to access, dispense and administer medications and to access and issue medical/surgical supplies.

Therefore, there exists a need to integrate these two systems, the pharmacy and the materials management, from the point-of-care, that is, from the perspective of the caregiver.

There exists a need to automate an integrated medication and medical/surgical supply system. There is a need to provide the actual caregivers with a user-friendly and convenient device for dispensing and administering medication and for issuing supplies directly at the point-of-care or point-of-use while at the same time accurately tracking and restocking the inventory and billing the patient for both the pharmacy and the materials management.

### SUMMARY OF THE INVENTION

The present invention allows a caregiver to use a single device to dispense and administer medications and to issue medical/surgical supplies. The administering of medications using the present invention provides for the automatic charting of the medications to a particular patient. The dispensing and administering of medication and the issuing of medical/surgical supplies using the present invention provides for the automatic tracking of inventory, restocking and billing to the pharmacy or materials management. The present invention system automatically tracks inventory movements of medications and medical/surgical supplies and notifies the pharmacy or the material management when stock reaches critically low levels for restocking and reordering.

The present invention also provides for a hand-held, wireless scanner that may be used at the point-of-care, that is at the bedside or room of the patient to verify, debit, credit and chart medication dispensing and administration while providing a legible, real-time medication administration record. Although in the present preferred embodiment a real-time hand-held device is described, other devices such as a wireless hand-held device, a wireless mobile laptop or PC, a laptop or PC with a RF card, a batch hand-held device, or a laptop or PC that is wired may be used.

The present invention provides for a device that may be used at the point-of-use, that is in the areas where supplies are kept, for managing supplies and capturing issuing information. Using bar code technology, or other methods of automatic identification such as RF ID, magnetic strip, etc., this device automates tracking, ordering and replenishing of medical/surgical supplies.

The present invention also provides for a system for reviewing patient orders on-line, reviewing a patient's history of dispensed and administered medications on-line, receiving discrepancy warnings prior to dispensing and administering medications, receiving immediate alerts of new, changed or canceled orders, capturing, billing and recording information into an electronic medication administration record (MAR), and charging upon administration. Reporting of transactions by various attributes such as users, medications, patients, locations, etc. can also be archived and reported by the system.

The present invention also provides for a system for tracking inventory, and capturing supply and procedure costs for both medications and medical/surgical supplies. The present invention provides real-time visual access to inventory levels, as well as critical supply level alerts at individual stocking locations, which virtually eliminates supply outages of both medications and medical/surgical supplies. The present invention reduces inventory counts from daily to weekly and allows the display of transactions by date, time and patient. The present invention automates ordering, counting, picking and replenishing activities, and eliminates keying/manual data entry of change items. The present invention also eliminates supply charge sticker costs and facilitates ongoing analyses with supply utilization reports while standardizing supplies and reducing inventory carrying costs. Reporting of transactions by various attributes such as users, supply, device, patients, locations, etc. can also be archived and reported by the system.

The present invention provides for a method of dispensing and administering medications and issuing medical/surgical supplies using a device communicating with a central database comprising the steps of: inputting information about a patient to the device for whom at least one medication may be dispensed and administered; dispensing the at least one medication to the patient by inputting information about the at least one medication to the device; saving the at least one medication to the patient selected; inputting information about a patient to the device for whom at least one medical/surgical supply may be issued; issuing the at least one medical/surgical supply to the patient by inputting information about the at least one medical/surgical supply to the device; and saving the at least one medical/surgical supply to the patient selected.

Additionally, the present invention provides for a method of issuing medical/surgical supplies using a device capable of dispensing and administering medication and issuing medical/surgical supplies in communication with a central database, comprising the steps of: recording the identity of the supply location; selecting a patient for whom at least one medical/surgical supplies will be issued; issuing at least one medical/surgical supply; and saving the at least one medical/surgical supply to the patient selected.

The present invention also provides for a method of issuing medical/surgical supplies using a device capable of dispensing and administering medication and issuing medical/surgical supplies in communication with a central database, comprising the steps of: recording the identity of the supply location; inputting information about a patient to the device for whom at least one medical/surgical supply will be issued; selecting a supply folder from a menu of the device; issuing at least one medical/surgical supply; and saving the at least one medical/surgical supply to the patient selected.

Further, the present invention provides for a method of dispensing and administering medication and issuing medical/surgical supplies using a device in communication with a central database, comprising the steps of: selecting a patient from the menu of the device for whom at least one medication will be issued; selecting a medication folder from a menu of the device for whom at least one medication will be dispensed and administered; inputting information to the device about the at least one medication to be dispensed and administered; scanning a patient ID bar code associated with the selected patient; saving the at least one medication to the patient selected; recording the identity of a supply location; selecting a patient from a menu of the device for whom at least one medical/surgical supply will be issued; selecting a supply folder from a menu of the device; issuing at least one medical/surgical supply; and saving the at least one medical/surgical supply to the patient selected.

The present invention provides for a device for dispensing and administering medications and issuing medical/supply items comprising: a barcode scanner for reading information; an optional touch screen; a radio communications unit for transmitting information; and a processor in communication with said scanner, touch screen and communications unit, said processor being programmed to enable the device to perform the following functions: dispensing medications, administering medications and issuing medical/surgical supplies.

The present invention provides for an administration system for dispensing and administering medications, issuing medical/surgical supplies, tracking, inventory, maintenance, and billing and restocking medications and medical/surgical supplies comprising: a central database; at least one device capable of receiving information associated with mediations and medical/surgical supplies and communicating via radio frequency information; at least one radio frequency access point for receiving radio frequency communications from the at least one real-time hand-held device and communicating the radio frequency communications to the central database; a decentralized storage location for dispensing medications; a decentralized storage location for issuing medical/surgical supplies; and a centralized system, responsive to the central database, for generating restocking packages.

The aforementioned advantages and benefits, as well as other advantages and benefits will become apparent from the Detailed Description of the Invention.

### BRIEF DESCRIPTION OF THE DRAWINGS

For the present invention to be easily understood and readily practiced, the present invention will now be described, for purposes of illustration and not limitation, wherein:

FIG. 1 is a diagram illustrating the relationship between a centralized storage location and, among other things, a plurality of storage locations;

FIG. 2 is a diagram illustrating a process for distributing items and restocking of items based, at least in part, on records created during distribution;

FIG. 3 is one example of hardware located at a decentralized location implementing a closed system for performing dispensing operations;

FIG. 4 is one example of hardware located at a decentralized location implementing an open system for performing dispensing operations;

FIG. 5 is a diagram illustrating the flow of information between the computers used at various locations within a dispensing/restocking system;

FIG. 6 shows a front view of an embodiment of the hand-held device of the present invention which may be used to scan medical items and a window showing internal components of the device;

FIG. 7 shows a back view of the embodiment of the hand-held device of the present invention as shown in FIG. 6;

FIG. 7A shows a top view of an embodiment of the hand-held device of the present invention;

FIG. 8 shows an LCD screen of the present invention displaying an example listing of patients;

FIG. 9 shows an LCD screen of the present invention displaying an example Security menu expanded;

FIG. 10 shows an LCD screen of the present invention displaying various medication folders and a supply folder;

FIG. 11 shows an LCD screen of the present invention with scroll bars displayed;

FIG. 12 shows an LCD screen of the present invention with a dialog box/window opened;

FIG. 13 shows a diagram of one example of a detailed medication administration process of the present invention;

FIG. 14 shows a logon screen of the present invention;

FIG. 15 shows LCD screen of the present invention which may be displayed during the assignment of patients to caregivers;

FIG. 16 shows an example of a Details function screen of the present invention;

FIG. 17 shows an LCD screen of the present invention with the PRN folder expanded;

FIG. 18 shows an LCD screen of the present invention with the Info folder expanded;

FIG. 19 shows an LCD screen of the present invention with the Due folder expanded;

FIG. 20 shows an LCD screen of the present invention with a Witness Administration dialog box expanded;

FIG. 21 shows an LCD screen displaying all patients in a particular unit by alias or room number of the present invention;

FIG. 22 shows an LCD screen displaying one embodiment of a Patient Issue screen of the present invention;

FIG. 23 shows an LCD screen displaying one embodiment of a Patient Issue screen of the present invention;

FIG. 24 shows an LCD screen displaying one embodiment of a Credit Item screen of the present invention;

FIG. 25 shows an LCD screen displaying one embodiment of a Patient Issue screen of the present invention in which all items are to be transferred from an empty room;

FIG. 26 shows an LCD screen displaying one embodiment of a Transfer Room screen display of the present invention.

### DETAILED DESCRIPTION OF THE INVENTION

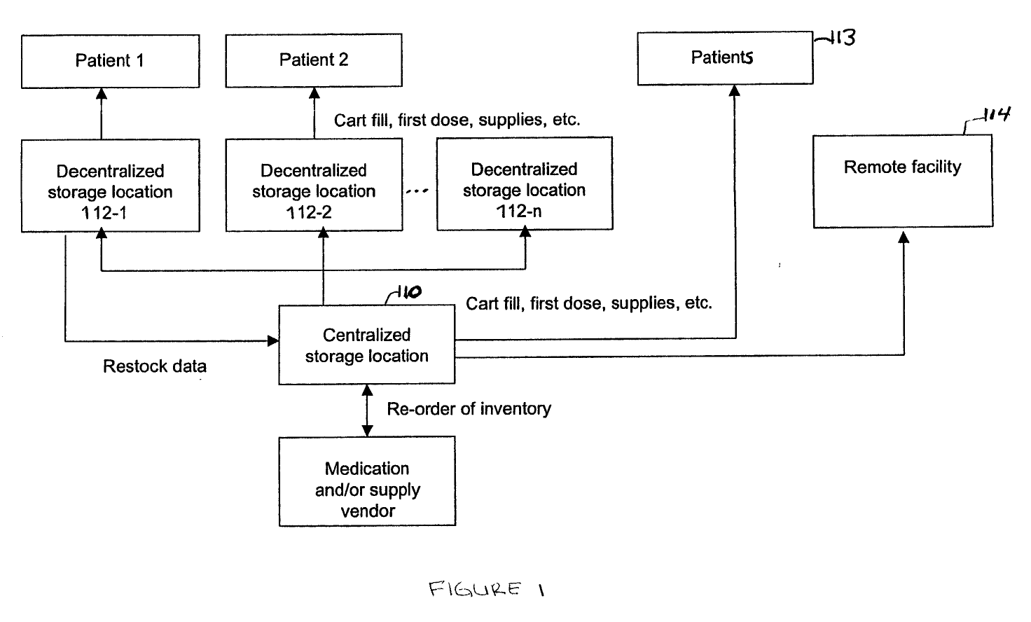

FIG. 1 is a diagram illustrating the relationship between a centralized storage location 110 and various inventory destinations, including a plurality of decentralized storage locations 112-1, 112-2 through 112-n, Ipatients 13, and a remote facility 114. In a medical facility, there may be two of these systems, one for the pharmacy and one for materials management. Each of the decentralized storage locations 112-1 through 112-n is capable of dispensing items stored at the location. The items may include medications, controlled medical supplies, medical supplies or items of a nature consistent with the facility in which the system illustrated in FIG. 1 is located. Items may be dispensed directly from centralized storage location 110 to patients 113, or from the centralized storage location 110 to a remote facility 114. Data typically flows from the decentralized storage locations 112-1 through 112-n to the centralized storage location 110. In response to that data, items are typically moved from the central storage location 110 to the decentralized storage locations 112-1 through 112-n or to the remote facility 114 to restock such locations to either replenish dispensed items or to stock new items. Decentralized locations could include satellite pharmacies, computerized medication cabinets, stationary/mobile medication carts, nurse servers, remote hospital pharmacies, supply closets, supply cabinets, etc. Supplies can be reordered from distributors based on levels of stock in the centralized storage location 110.

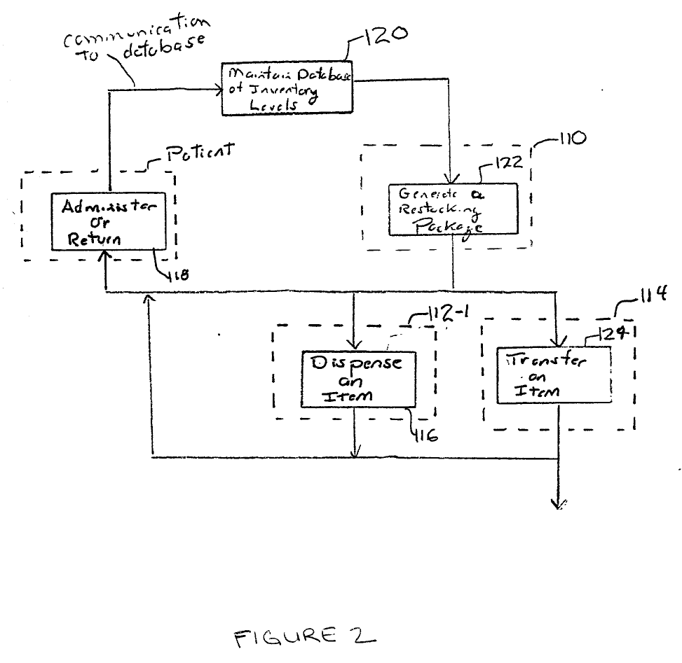

FIG. 2 illustrates a process which may begin with a step of dispensing an item at step of 116 from one of the decentralized storage locations 112-1 to a patient. A dispensing operation may occur in a variety of ways. In a medical facility, dispenses may be completed from medication orders or they may be completed from inventory lists, to name a few types of dispensing operations. Assuming a medication has been dispensed from decentralized storage location 112-1, the medication may either be administered to a patient or returned as shown by step 118. Medications may be returned for a variety of reasons such as the patient has checked out, been moved, or the patient's medication may have been changed. Medications may be returned to the decentralized storage location 112-1. Certain types of medications may simply be replaced in the decentralized storage location 112-1 so as to be used in another dispensing operation, or may need to be disposed of.

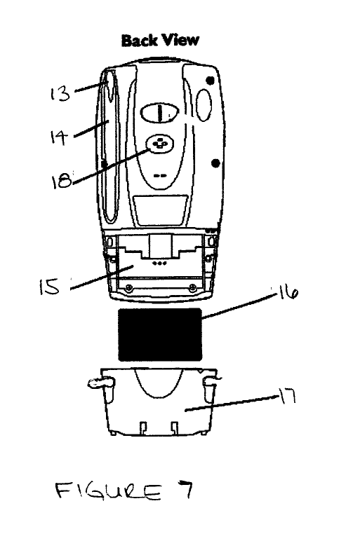

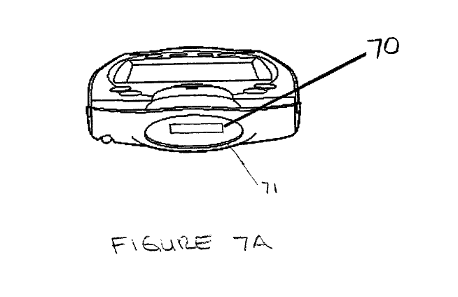

The administration of medications occurring at step 118 may be carried out through the use of the hand-held device of the present invention (shown in FIGS. 6 and 7). Although in the present preferred embodiment a real-time hand-held device is described, other devices such as a wireless handheld device, a wireless mobile laptop or PC, a laptop or PC with a RF card, a batch hand-held device, or a laptop or PC that is wired may be used. Such devices communicate with a database to verify the administration of medications to patients. Such communications enable the maintenance of a database of inventory levels as shown by step 120. The database and associated computer system for maintaining the database of inventory levels may be located at the centralized storage location 110 or may be located remote therefrom. In either event, the computer system necessary for maintaining the database provides information which enables the centralized storage location 110 to perform step 122 of generating a restocking package. The generation of the restocking package may be done completely automatically, manually, or through some combination of manual and automatic processes. The restocking package is used to restock the decentralized storage location 112-1. Restocking packages may also be generated at centralized location 110 and delivered to the remote facility 114. From facility 114 an item may be transferred as shown by step 124. The transfer may be a dispensing step for a patient or a transfer to another location. Items may also be dispensed directly to the patient from the centralized location 110.

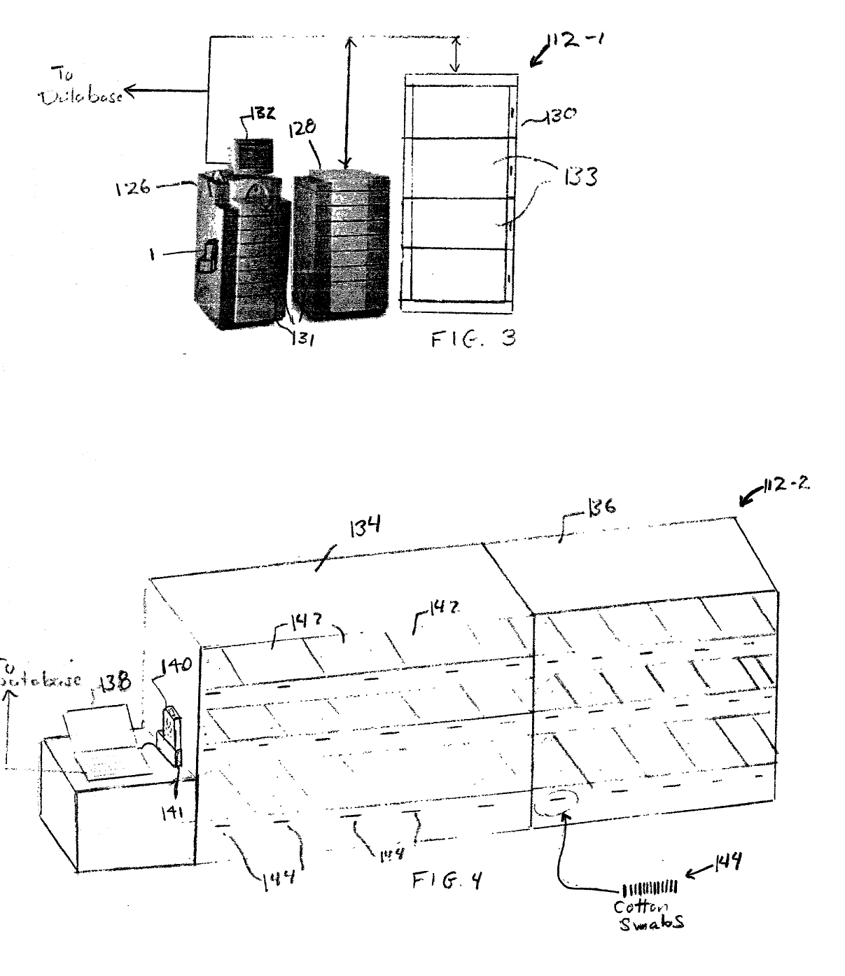

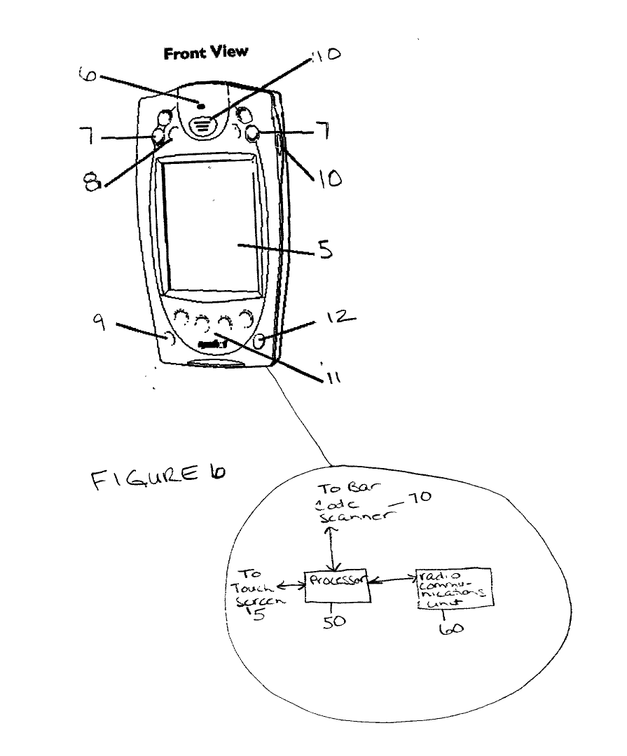

FIG. 3 illustrates one example of hardware which may be located at any of the decentralized locations 112-1 through 112-n. The hardware illustrated in FIG. 3 is comprised of an AcuDose-Rx™ cabinet 126, having a control computer 132, and an AcuDose-Rx™ auxiliary cabinet 128, available from McKesson Automation, Inc. A supply tower 130 is also illustrated. The control computer 132 controls the operation of the cabinet 126, auxiliary cabinet 128, and supply tower 130. The control computer 132 is also in communication with the central database. Hand-held device 1 may communicate via radio frequency access points 2 (shown in FIG. 5) with computer 190 (shown in FIG. 5). The radio frequency access points 2 provide a bridge between the wired LAN and any number of wireless devices with antennas usually attached and mounted in the ceiling of the nursing unit. The radio frequency access point equipment is designed and manufactured by Symbol Technologies, Inc.

To perform a dispensing/issuing operation a user logs onto the control computer 132. Thereafter, patient information and information regarding items to be dispensed is entered. Based on the entered information, various drawers 131 in the cabinet 126 and the auxiliary cabinet 128, and various doors 133 on the supply tower 130 are unlocked. The items to be dispensed/issued may include medications or medical/surgical supplies. After the item to be dispensed/issued has been removed, its removal is recorded at the control computer 132. The user may continue to dispense items for the identified patient, or patient information for another patient may be entered. Entry of information, including log-in, can be performed in a variety of ways, e.g., through entry with a keypad, barcode scanning, or selecting items from a pick list, RF ID, flash memory, magnetic strip OCR, etc. Note that computerized medication cabinets like the AcuDose-Rx cabinet can also track medications or supplies that are not stored in the cabinets 126, 128 or tower 130. For example, the control computer 132 can track virtual inventories, i.e., medications stored outside the cabinets 126, 128 or tower 130. Examples include medications stored in a refrigerator whose inventory and transactions are recorded by the control computer 132. The reader will understand that the hardware illustrated in FIG. 3 is exemplary and is illustrated for purposes of demonstrating one type of hardware which may be located at the decentralized storage locations 112-1 through 112-n.

The hardware illustrated in FIG. 3 limits access to the items to be dispensed to those individuals who have properly logged on. Thus, the hardware illustrated in FIG. 3 is referred to as a closed system for performing dispensing operations because a dispensing operation cannot be performed unless the user is identified to, and recognized by, the control computer 132.

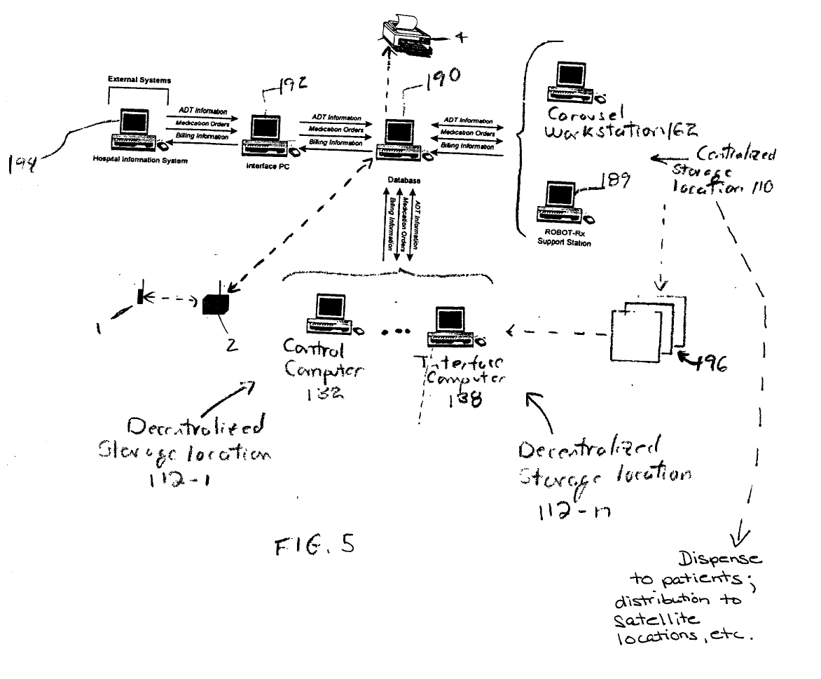

FIG. 4 illustrates another example of hardware which may be located at any of the decentralized storage locations 112-1 through 112-n. The hardware is comprised of a first shelving unit 134 and a second shelving unit 136. Optionally, an interface computer 138 is provided, which is in communication with the database. If the interface computer 138 is not provided, a hand-held device 140 can be carried into the area to perform the inventory of the shelves. The hand-held device 140 is taken back to the centralized storage location 110 where the information is downloaded in any appropriate manner. Alternatively, the hand-held device 140 could be a wireless device communicating over a wireless network link. Alternatively, and as shown in FIG. 4, the hand-held device 140 may be located in the area and have a docking cradle 141 in communication with the interface computer 138. Each of the shelving units 134, 136 is comprised of a plurality of bins 142. Each of the bins carries indicia 144 which may be, for example, a barcode and/or a label identifying the contents of the bin. Additionally, items in the bins may have a bar code, label or other indicia directly on them or on their packaging. The bar code could be scanned, or other methods of inputting the data consistent with the type of indicia used, or push buttons or the like actuated, to perform a dispensing or other type of operation. In addition, the hand-held device 140 could be used to generate an ad hoc order through its screen entry in the event that an items not available to be scanned or otherwise have data pertinent thereto input. The number of shelving units 134, 136 and the configuration of the bins 142, depends upon the number and size of the items to be stocked. Because access to the bins 142 is not restricted, the hardware illustrated in FIG. 4 is referred to as an open system for performing dispensing operations. The reader will understand that the hardware illustrated in FIG. 4 is exemplary and is illustrated for purposes of demonstrating one type of hardware which may be located at the decentralized storage locations 112-1 through 112-n.

The hand-held device 140 may be a wireless scanning device such as Symbol 7240 or Welch Allyn 7400. Optionally, batch hand-helds and docking stations can be used. In one mode of operation, the operator may use the hand-held device 140 to scan the barcode indicia 144 for each bin (or alternatively the supply) for which a restock is desired. The operator will then input the order quantity on the hand-held device 140. When the hand-held device 140 is docked in its cradle 141, the data will be downloaded. The data will then be queued to be processed to generate a restocking package. Use of the hand-held device 140 eliminates the manual task of ordering items to be restocked, and reduces the potential for errors.

Hand-held device 1 of the present invention has traditionally been used only for the dispensing and administering of medications in conjunction with cabinets 126, 128 of the type shown in FIG. 3. According to the present invention, the functionality of hand-held device 1 is expanded so that the operator may use hand-held device 1 to scan the barcode indicia 144 to issue an item or medical/surgical supply to a patient as will be described hereinafter.

FIG. 5 illustrates the computers used at various locations within a dispensing/restocking system of the type disclosed herein. As seen in FIG. 5, decentralized storage location 112-1 is where control computer 132 (if supplied) is located. Decentralized storage location 112-n is where interface computer 138 (if supplied) is located. Device 1 communicates via radio frequency access points 2 with computer 190. Attached to computer 190 are printers 4 for requesting reports and the printing of patient identification wristbands. Optional centralized automation such as a Robot-Rx™ robot or a dispensing carousel can also be included. A carousel work station 162 is located at the centralized storage location 110. The centralized storage location 110 may also have a Robot-Rx™ support station 189 which is used to control a robot. Other types of hardware which may be used at the centralized storage location 110 include a system of the type disclosed in U.S. Pat. No. 5,593,267 entitled “Automated System for Selecting and Delivering Packages from a Storage Area”, U.S. Pat. No. 5,880,443 entitled “Automated System for Selecting Packages from a Cylindrical Storage Area”, and U.S. patent application Ser. No. 09/480,819 entitled “An Automated Medication Dispensing System”, all of which are hereby incorporated by reference.

A computer 190, which may be located at centralized storage location 110 or may be located elsewhere, maintains the database for the system. The computer 190 receives information from the decentralized storage locations 112-1 through 112-n and provides information to the carousel work station 162 and/or the Robot-Rx™ support station 189 to enable restocking packages 196 to be prepared. Additionally, dispenses to patients, distributions to satellite facilities, and the like may occur from centralized location 110. An interface PC 92 may be provided to enable external systems, such as a PC 94 on which a hospital information system resides, to communicate with the computer 190 on which the database is located. Completing the description of FIG. 5, as has been previously described, restocking packages 196 are prepared at the centralized storage location 110 and delivered to the decentralized storage locations 112-1 through 112-n.

FIG. 6 shows a front view of one embodiment of hand-held computer device 1 used to scan medications and medical/surgical supplies and a window showing internal components of device 1. Device 1 is a hand-held barcode scanning devices with software that accesses user, patient, and medical records via a Microsoft®, Palm OS, or other open systems platform from the hospital and pharmacy information systems. Device 1 may be carried by the caregiver during medical administration rounds. Device 1 may also be carried by the caregiver to supply storage locations to allow for real-time tracking of inventory assignments to a particular patient. Device 1 may include a LCD display or screen or touch screen 5 where the administration system software may be displayed. Device 1 may further include scan LED 6 which indicates when the scanner is in use. LED 6 may initially be red while scanning unsuccessfully and may be green when scanning is successful. Scroll buttons 7 may be provided to work much like vertical scroll bar on a PC to move the screen up and down. Action button 8 may be used to confirm an action. That is, action button 8 may be used to confirm that a medication or medical/surgical supply has been dispensed or issued to a particular patient. Action button 8 can be used instead of an “ok” or “enter” within the software. Power button 9 may be provided to turn device 1 on and off. Scan triggers 10 may be provided on the right, left and/or center of device 1. To scan an item, the user should press scan trigger 10 while the laser light is directed at the barcode of the item to be scanned. The user should continue to press scan trigger 10 and aim the laser until a successful scan beep is heard and scan LED or scanner indicator light 6 is green. Application button 11 may be provided to allow the user to reboot the system. Function button 12 may be provided to be used in conjunction with another button (not shown) to perform hardware operations such as recalibrating the screen and screen adjustments. Note that the device is also capable of generating audible sounds.

The window of FIG. 6 shows internal components of device 1. The window shows that device 1 includes bar code scanner 70 (see FIG. 7A) for reading/inputting information, radio communications unit 60 for transmitting and receiving information and processor 50. Processor 50 is programmed to perform the following functions: dispensing medications, administering medications and issuing medical/surgical supplies.

FIG. 7 shows a back view of one embodiment of hand-held computer device 1 used to scan medications and medical/surgical supplies. Device 1 may include stylus or pen 13 which may be used to touch LCD screen 5 to communicate with device 1. Device 1 may also include stylus silo 14 to store stylus 13 on the back of device 1. Battery compartment 15 may be provided to store battery 16. Battery cover 17 may be provided to secure battery 16 within battery compartment 15. Device 1 may also include speaker 18 to provide an audible beep to indicate when a scan has been successfully completed. An optional strap can be attached to the back of the device.

FIG. 7A shows an end view of device 1. Device 1 may also include scanner window 71 which is where the laser beam of barcode scanner 70 is transmitted.

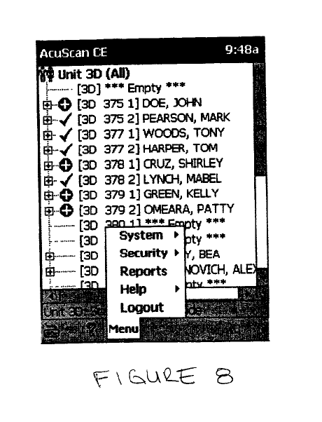

FIG. 8 shows LCD screen 5 displaying an example listing of patients in Unit 3D of a hospital or medical facility. The display shows in brackets, the room number and bed number, followed by the patient name. At the bottom of LCD screen 5 is the menu located on the task bar. The display shows the menu opened to show various folders located within the menu. The System menu provides information regarding the particular device 1 that is being used. A caregiver can also log out or upgrade the unit from the System menu.

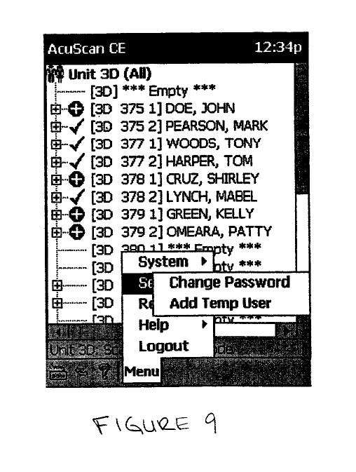

FIG. 9 shows LCD screen 5 displaying an example listing of patients in Unit 3D with the Security menu opened on the task bar. The Security menu allows all users to change their passwords. In addition, those users with the appropriate security privileges may add temporary users to the system. The Reports menu (not shown) allows reports, including the printing of patient wristbands, to print on the printer associated with device 1. The administration system provides a series of reports for supervisors to generate. The Help menu (not shown) provides for online assistance from every screen in the software. The Help menu will provide information regarding the screen from which the Help menu is accessed.

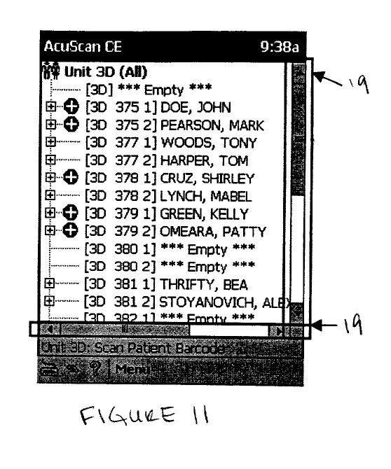

A caregiver may select a patient from LCD screen 5 shown in FIG. 8. In one embodiment of the present invention, once a patient has been selected, LCD screen 5 may be organized according to various medication folders and a supply folder as shown in FIG. 6. The medication folders can include: Due, PRN, Hold, Without Rx, IV, Respiratory Therapy, New, Active and Discontinued. Each medication folder contains a specific type of medication ordered for that patient. Upon selection of a patient, the Due folder expands. To view the contents of a folder, the folder must be expanded. To expand the folder, the caregiver taps the “+” to the left of the desired folder. When a folder is expanded, LCD screen 5 displays the appropriate medications for that patient. Once the folder has expanded, the “+” changes to a “−”. To collapse the folder, the caregiver taps the “−” to the left of the expanded folder. If a window is not large enough to display its contents completely, scroll bars 19 are displayed as shown in FIG. 11. Scroll bars 19 allow the caregiver to maneuver within the window to the left, right, up or down.

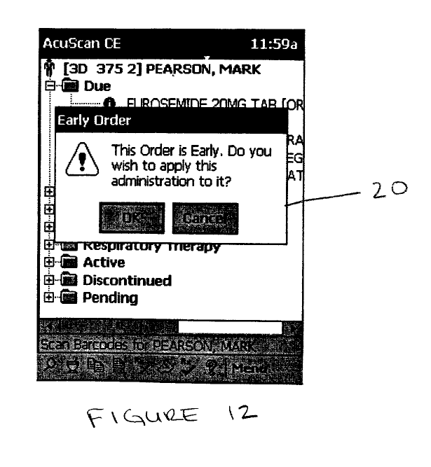

FIG. 12 shows LCD screen 5 with dialog box 20 opened. Dialog box 20 is a small window that appears over the current screen displayed. In the present invention administration system dialog boxes 8 display to provide warnings to the caregiver or to ask for confirmation from the caregiver of certain actions. Once dialog box 20 opens, it must be addressed before the caregiver may proceed. Tapping OK on dialog box 20 accepts the information being entered or the action being performed. Tapping CANCEL on dialog box 20 cancels the information being entered or the action being performed.

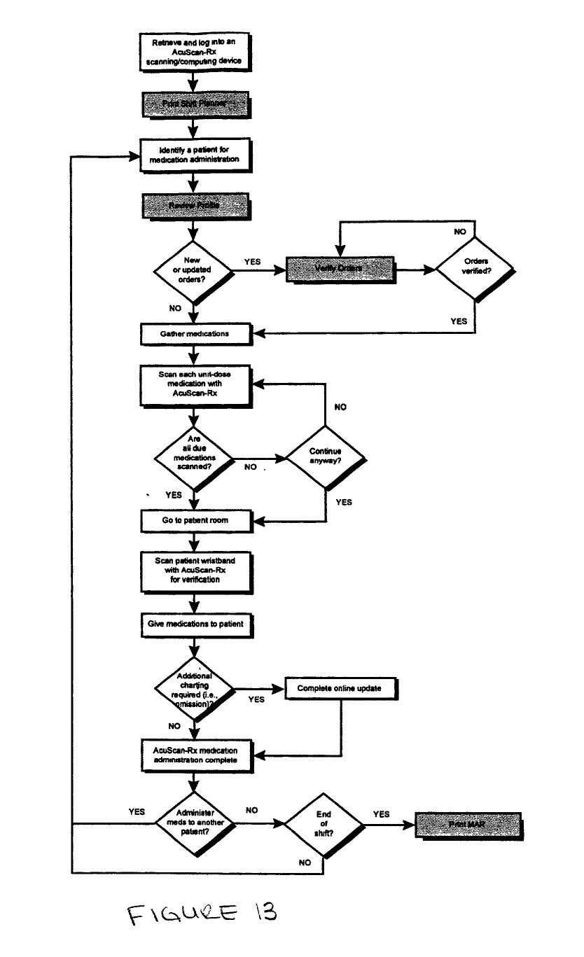

The process of dispensing and administering medication is as follows: log in; identify the patient to whom you are dispensing and administering the medications; scan the medications to dispense and administer; and confirm the identification of the patient. Because all of these steps are automated, the medication administration record is automatically created and the caregiver is then ready to begin dispensing and administration for the next patient. FIG. 13 is a diagram of the detailed medication dispensing and administration process. The grayed boxes indicate major tasks, which will be discussed more fully below.

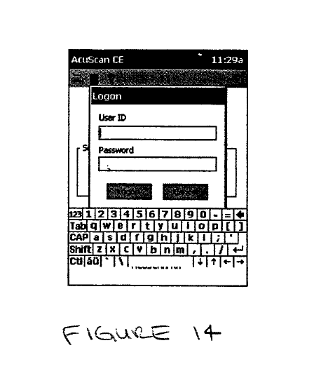

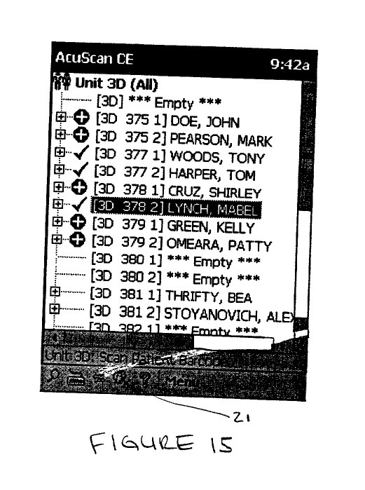

Before dispensing and administering medications, caregivers must logon to the system. Two different ways to logon will be discussed, although it is understood that the logon process may be accomplished in any other suitable manner. Both of the logon processed discussed start from the logon screen as shown in FIG. 14. To logon, the caregiver can either: (a) scan the caregiver's assigned user barcode; or (b) tap the icon associated with the keyboard on LCD screen 5, use stylus 13 to enter the caregiver's assigned user ID and password. If the caregiver has not yet assigned patients to their user ID, upon completion of the login all patients on the caregiver's entire unit display on LCD screen 5, showing all of the names of the patients assigned to that unit. If the caregiver has previously assigned patients to their user ID, upon completion of the login, only previously assigned patients are displayed on LCD screen 5. Patients may be assigned to a caregiver after that caregiver has logged in. To assign patients to their user ID the caregiver highlights a patient that they wish to add to their assigned patients, and tap a key to select that highlighted patient. This results in a check-mark being placed next to the selected patient's name as shown in FIG. 15. This may be repeated until all of the desired patients have been assigned. To un-assign patients the caregiver must highlight the patient that they wish to remove from the list and tap deselect icon 21. The patient then is no longer marked with a check mark.

The present invention provides for five ways to select a patient. A patient may be selected by: (1) scanning the patient's wristband barcode; (2) scanning the patient's medication cassette barcode; tapping the icon associated with the keyboard and typing the patient's ID into device 1; (4) double tapping the patient's name when it is displayed on the screen; and (5) tapping the patient's name and then selecting the + to the left of the patient's name.

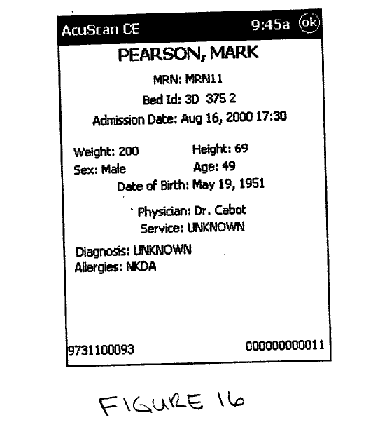

The present invention also provides for a Details function which allows the caregiver to view more demographic information about a specific patient. The patient information available includes: the medical records number, bed, admission date, weight, height, sex, age, date of birth, physician, service, diagnosis and any allergies. An example of the Details function screen is shown in FIG. 16.

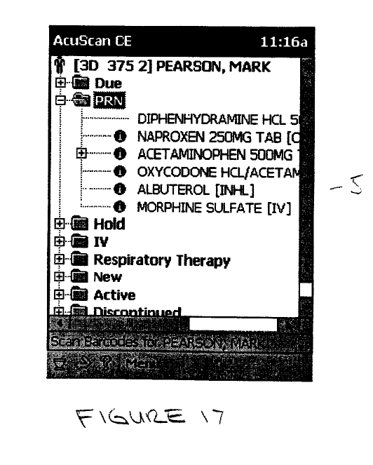

As previously discussed, patient's orders are categorized into folders within the administration system. Once the patient has been selected the Due orders screen appears. The Due orders folder is the default view after selecting a patient. For all order types, the patient location and names are listed at the top of the screen. Below the patient's name is the title of the order type selected. All medications preferably listed chronologically in order of administration time. The order types to view are PRN, Hold, IV, Respiratory Therapy, New, Active, Discontinued, and Without Rx. Each folder within the order type menu can be expanded and collapsed as needed. When the folder is expanded, it displays the appropriate medications. Each listed medication includes the drug name, dose, and form in which it is taken. Some folder views, such as Due orders folder, also display the date and time of medication administration. To access other folders, the caregiver must first collapse the Due orders folder by tapping “−” to the left of the Due folder. After collapsing the Due orders folder, the menu of all order types appears. The caregiver taps the “+” next to the order type that he wishes to expand. FIG. 17 shows the LCD screen 5 with the PRN folder expanded. It should be understood that other types of folders to track specific types of medications or supplies are possible to be configured.

The Due order folder contains orders which are due to be administered within a timeframe specified by the hospital. The medication is preferably sorted by date. Each dose administration is listed separately according to its ordered time. The drug name, dose, and form of the medication are shown. Also, any past due medications are listed on this screen and must be resolved before they are removed from the due list. An icon may be provided on the order to indicate that it is a past due order. If there are two or more doses of a medication displayed, and at least one of which is past due, the dose that was due earliest is selected to administer.

The PRN folder lists all PRNs ordered for the patient. The drug route, name, dose and form of the medication display. To the left of the medication a “+” appears if it has already been administered. The caregiver may tap the “+” to view when the PRN was given last, and tap the “−” to hide the time again.

The Hold folder lists the medications that the physician has ordered to be put on hold. The drug route, name, dose and form of the medication display.

The Without Rx folder lists the medications being administered without pharmacy review. The nursing staff entered the order, and these orders are considered to be unreconciled. If a medication has a scheduled administration time, the date and time may appear. The drug route, name, dose and form of the medication display. Orders listed in this folder are usually considered stat, one-time orders, or orders entered when the pharmacy is closed.

The IV folder lists the continuous IVs and non-continuous IVs ordered for the particular patient. If a medication has a scheduled administration time, the date and time appears. The drug route, name, dose and form of the medication display. Continuous IVs do not have scheduled administration time. They appear in the IV and Active folders only.

The Respiratory Therapy folder lists medications used for respiratory therapy. If a medication has a scheduled administration time, the date and time appears. The drug route, name, dose and form of the medication display.

The New folder contains new orders that have not yet been verified by a nurse. All new orders must be optionally checked before they can be administered. If a medication has a scheduled administration time, the date and time appears. The drug route, name, dose and form of the medication display. As new orders are verified against the physician orders they are removed from the New folder.

The Active folder for a particular patient lists medications that are PRN, Stat or one-time orders, or scheduled orders. Medications that have been discontinued do not display. Medications that are past due or on hold display on the list. The list may be viewed by next due time or alphabetically.

The Discontinued folder contains a list of all medications that the physician has discontinued for the patient. If a medication has a scheduled administration time, the date and time appear. The drug route, name, dose and form of the medication display.

The Pending folder lists pending orders during medication administration. This folder lists all mediations scanned for administration.

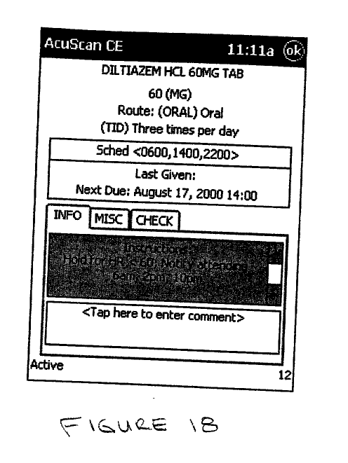

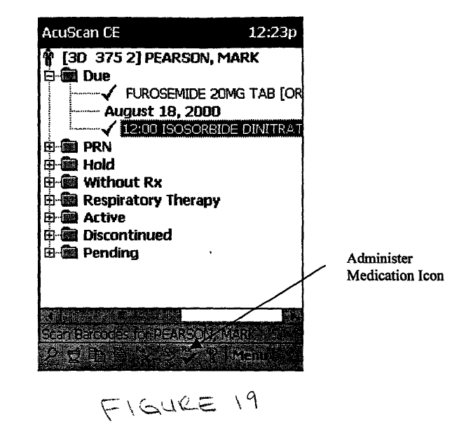

The Details function (as discussed in connection with FIG. 16) also allows the caregiver to view more information about a medication on the patient profile. This function provides the drug name, dose and form, the route, frequency and times it is scheduled; when it was last given and when it will be due again. The caregiver may edit or enter the scheduled administration times (if the medication is not due), comments, enter a reorder date, disable an order or change an IV rate. The Details function also provides for the following options: Info, Misc, Check, and Soln. Info as shown in FIG. 18 shows any additional instructions for administration deemed necessary by the physician or pharmacy. From this view the caregiver can also enter comments on the medication for the patient. The caregiver is preferably not able to edit a comment that the pharmacy has entered. Entering a comment is not the same as editing the record and adding an observation, which pertains only to the caregiver's administration. The Misc displays the date the order was started and when the order will expire. From this view the caregiver may also enter a date to reorder this medication for this patient. The Check allows the caregiver to verify the medication before administering it for the first time. If the medication requires a witness on administration, it will state Witness Required under Other. The Soln (not shown) displays the base, the components, and the give rate for an IV medication. The Soln preferably only displays for IVs.

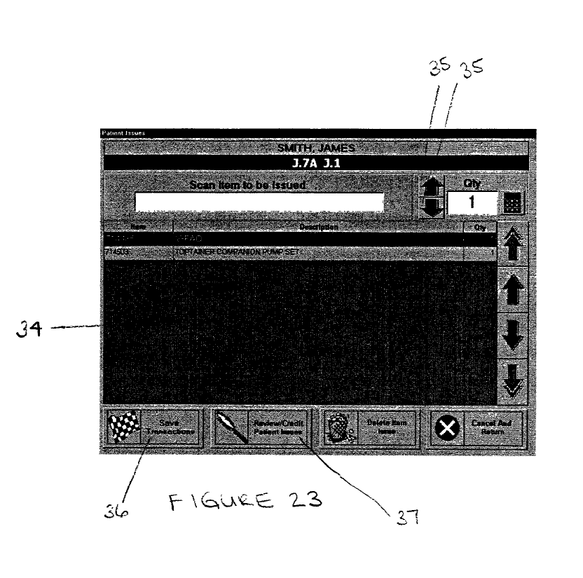

As previously discussed, a caregiver may administer dispense and medications by scanning the barcode of that medication. A caregiver may only administer a dispense and medication without a barcode from the Due orders, Active, PRN, or IV folders. To dispense and administer medications to a patient, the caregiver selects a patient and they are then taken directly to the patient's Due orders folder. FIG. 23 shows the Due folder open for a particular patient. The caregiver then may scan the barcode of the medication to be dispensed and administered. After scanning, the appropriate folder opens with the medication highlighted. The caregiver may scan all medications in this fashion. The caregiver will receive a warning if they have deviated from the active profile of the patient selected. The system may provide to the caregiver an icon next to a medication to indicate that the caregiver should visit the Check medication or Details section. If the medication is past due, a warning indication icon may be displayed next to the medication. The caregiver may then be prompted to select a reason why the dose was administered late. The medication may then be displayed with a check mark next to the dose being administered. The caregiver must tap the check mark when they are ready to administer the medication to the patient. If they wish to cancel the administration, a cancel icon should be tapped. If there is another medication due at the time of the administration, a warning may appear. The caregiver may tap OK if they wish to continue with the original administration or tap CANCEL if they wish to cancel the administration. The caregiver should then scan the patient's wristband. This confirms the identity of the patient to whom the caregiver is administering medications. The caregiver preferably cannot manually enter information for this part of the administration process. The medications are listed under the Pending Orders folder in the main orders type menu Once the caregiver has confirmed that the patient has taken the medication, the caregiver may tap a chart icon to complete the charting process. The caregiver is then returned to the census screen.

As previously mentioned, if it is not possible to scan a barcode, the caregiver may still dispense and administer the medication. This is useful when the barcode cannot be scanned or if the packaging has accidentally been discarded prior to scanning. The caregiver can only dispense and administer medication without scanning the barcode from the Due, PRN, or Active folders. To dispense and administer a medication without scanning the barcode, the caregiver first selects the patient, then highlights the medication that he wishes to dispense and administer. The caregiver then taps an icon which results in a dialog box appearing to ask for confirmation that the caregiver wishes to dispense and administer the medication non-bar-coded. The caregiver taps OK in response, and the medication appears with a checkmark next to the dose. The caregiver may then continue dispensing administering medications.

Additionally, hospitals or care facilities may require that certain medications require a witness during administration. The present invention administration system provides a witness required icon next to all medications which require witnesses for administration. In this situation, the caregiver first selects the patient, then scans the bar code of the medication to be dispensed and administered, then taps the witness required icon. At this point the Witness Administration dialog box displays, as shown in FIG. 16. The witness then scans his/her ID badge or barcode. They are witnessing the dose and drug being administered. The witness then enters his/her password and taps OK. The caregiver may then continue with medication administration.

A caregiver may need to create a STAT or one-time order if the pharmacy is not open 24 hrs. a day, seven days a week. The medication may still be dispensed and administered using the formulary to create a new order. The caregiver can create a one-time order or a scheduled order for the hours that the pharmacy is closed. To dispense and administer a medication without a pharmacy order, from the patient's Due orders folder, (1) the caregiver should tap an icon which signifies the formulary. The formulary list will then appear. Alternatively, the caregiver can scan the medication barcode. If the caregiver chooses to scan the medication barcode, then the caregiver will proceed directly to (7) below. Next, (2) to find the correct medication, the caregiver can perform one or more of the following: use the vertical scroll bar to view additional medications, tap a next page icon to move forward one page or a previous page icon to move backward one page, and tap an icon to alternate from generic or brand name lists. Next, (3) the caregiver should highlight the medication to be ordered. At this point, mediation details may be viewed if desired. Then (4) the caregiver should tap an icon which indicates Rx, and (5) tap OK to confirm this medication. (6) If OK is tapped again, the caregiver can view the patient's allergies, and can then tap OK to hide the allergy listing. Next, (7) It is possible for the caregiver to edit the Dose, Route, and Schedule. The caregiver may also enter a Note for this order. The caregiver should then (8) tap OK when finished.

It is possible for the caregiver to edit the Medication Administration Record (MAR) of a patient after completing an administration. The MAR is the official medication administration record for the patient during his or her hospital stay. The information available in the MAR includes: the Drug Name, Dose and Form, the Scheduled Time, the Actual Time Giver, the User, the Dose, the Site of Administration to the patient, an Observation made at the time of administration and the Status of the Administration. A caregiver can only edit administrations that he himself has performed. However, if another user performed the administration, the caregiver may still enter an observation.

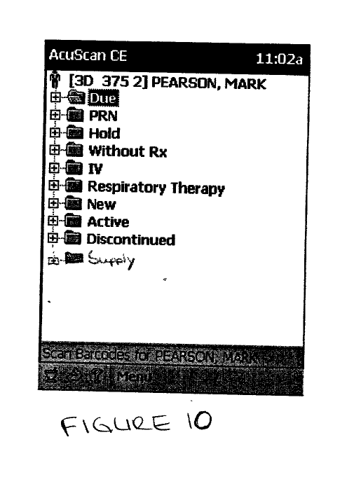

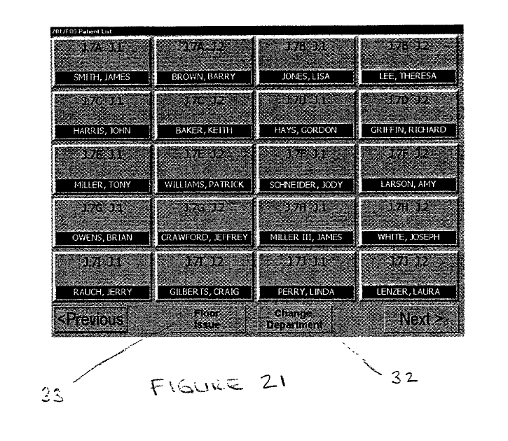

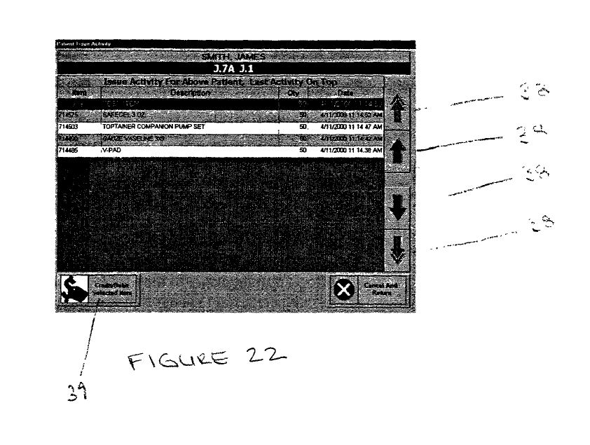

As previously discussed, device 1 may also be carried by the caregiver to supply storage locations to allow for real-time tracking of inventory assignments of medical/surgical supplies to a particular patient. FIG. 21 shows a Patient List screen which identifies various patient and which screen is an alternative to the screen as shown in FIG. 8. Once a patient is chosen, the caregiver is taken to the window/screen as shown in FIG. 10. As shown in FIG. 10, it is possible for the caregiver to enter the Supply folder to issue medical/surgical supplies. Once the Supply folder is expanded, the Patient Issues screen, as shown in FIG. 22, may be displayed. The Patient Issues screen is considered the primary work area for the caregiver. When supplies are issued to a patient, the caregiver is responsible for ensuring that the supplies given are charged and accounted for. These caregivers will issue supply items to patients as well as to the department. To issue an item to a patient, the caregiver must select the patient in the system, scan the bar code of each supply being issued, and enter the quantity of each supply item if scanning more than one. Optionally, the software can list a comprehensive list of supplies for that location and the user can pick the supply they are interested in if scanning is inconvenient. This process will decrement the unit's inventory and start the replenishment process. In addition, the patient is charged for each item scanned against their room. If an item scanned is not a patient-chargeable item, the item automatically charges to the department. The caregiver may also charge items to the department by selecting the Floor Issue option. The caregiver may perform any one of the following options: issue items to patients; credit or debit issued items; issue items to an empty bed; issue items to the Floor rather than to a patient; transfer empty room charges; and issue items when not in the caregiver's Department.

To issue an item, the caregiver must first select a patient, verify the room and bed number, capture the type and quantity of a supply by scanning, complete the transaction and issue the item. Each supply item that is issued to a patient is entered into the system by scanning the barcode associated with that item or shelf location. When issuing an item the system tracks the supplies given to each patient in addition to decrementing the inventory level for the supplies issued. All transactions can be reported based on a variety of attributes including but not limited to patient, supply, location, etc.

As shown in FIG. 21, the Patient List screen displays all patients in the unit by alias or room number. It is possible to create an alias for a patient in the Room Maintenance portion of the Material Management application. If an alias has been created, the alias will appear on the Patient List, Patient Issues, Edit Item, Credit Item, and Transfer screens in the application. If the Alias field is blank, the room number identification as passed from the information system will instead display. Buttons 32, 33 may be located at the bottom of the Patient List screen as shown in FIG. 21. Change Dept. button 32 allows the caregiver to view the beds and patients for another department. Floor Issue button 33 accesses the Patient Issues screen (as shown in FIG. 22) allowing the caregiver to issue supplies to the department, location, or hospital service. An optional Logout button (not shown) may be provided when the system has been configured to require user login. In this instance, the user will have to log out of the system when they have completed issuing supplies.

To issue supplies, the caregiver must first log into the system and choose a particular patient. At this point the caregiver will view the screen as shown in FIG. 10 and they may enter any number of medication folders for the patient or a supply folder. Upon entering the supply folder for a particular patient, the caregiver will be at the Patient Issue screen as shown in FIG. 22. The caregiver should then scan the items that are being issued to the patient. The items display in Issue Activity THIS Session 34 portion of the screen as shown in FIG. 23. When issuing items, the quantity defaults to one. To issue more than one of the same item or to change the quantity issued, the caregiver may do one of the following: highlight the item (if already scanned) and then adjust the quantity using arrows 35, or scan the item's bar code multiple times to enter multiple quantities. Next the caregiver should touch save transactions icon 36 to save the patients issues.

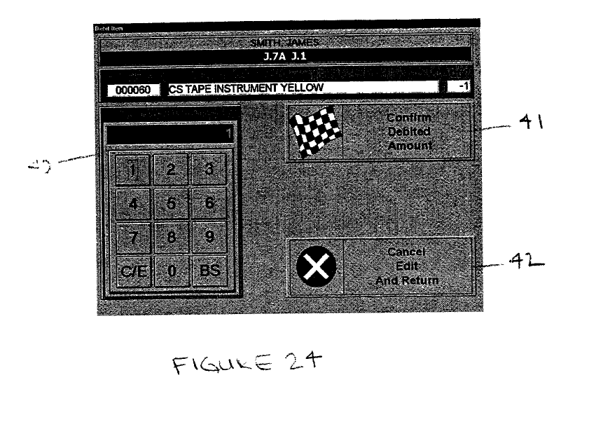

It is also possible for the caregiver to review all of the items issued to a specific patient and to credit or debit specific items as needed. The caregiver may not credit more than the amount issued. Each transaction will appear on the Patient Issue screen as shown in FIG. 22. The issues are listed chronologically with the most current item listed first on list. From the Patient Issues screen as shown in FIG. 23, the caregiver may tap review/credit patient issues button 37. The Patient Issue Activity screen displays as shown in FIG. 22. The caregiver may select the item that they would list to credit using arrow buttons 38. When selecting an item to credit, the caregiver must select a positive number in the quantity column. The caregiver then selects Credit/Debit Selected Item button 39. The Credit Item screen then displays as shown in FIG. 24. Using keypad 40, the caregiver may enter the quantity of the item that he would like to credit. The caregiver then touches Confirm Credit Amount icon (not shown) to adjust the quantity entered for the supply item. The caregiver is then returned to the Patient Issue Activity screen as shown in FIG. 22 and the item credited displays at the top of the current list of items issued. If the caregiver chooses not to credit the current item, they may touch Cancel Edit and Return icon 42 as shown in FIG. 24.

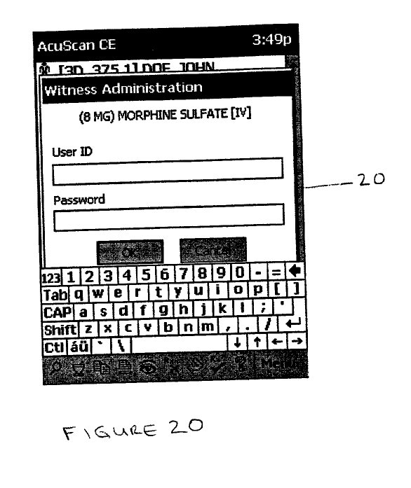

To debit a supply item, from the Patient Issue screen as shown in FIG. 23 the caregiver may touch Review/Credit Patient Issues button 37. The Patient Issues Activity screen as shown in FIG. 22 displays. The caregiver may select the item that he would like to debit using arrow keys 38, and then select Credit/Debit Selected Item icon 39, and Debit Item screen as shown in FIG. 24 appears. Using keypad 40, the caregiver may touch the quantity of the item that he would like to debit. When selecting an item to debit, the caregiver must select a negative number in the quantity column. The caregiver then touches Confirm Debited Amount icon 41 to add the quantity entered. The caregiver may return to the Patient Issue Activity screen as shown in FIG. 22 and the item debited displays at the top of the current list of items. Alternatively, the caregiver may select Cancel Edit and Return icon 42 as shown in FIG. 20 to return to the Patient Issue Activity screen as shown in FIG. 22.

Device 1 will be installed in multiple departments at each hospital or facility. Device 1 may be assigned to a particular department. However, it is possible to view different departments and patients from device 1 to which it is not assigned. The other department's inventory will be decremented for the items charged to the patient. Each room in the new department will show the patient's name only if the cloak option is not enabled during configuration. Otherwise, if cloaking is enabled, an “Occupied” will show instead of the patient name.

To issue items when the caregiver is not in their assigned department, from the Patient List screen as shown in FIG. 21, the caregiver taps Change Department icon 32, and a screen appears which displays all of the departments (not shown). From this screen the caregiver may tap their department and the Patient List screen as shown in FIG. 21 shows for that department selected. The caregiver may then complete whatever transaction is necessary for the patents in the changed department.

Additionally, a caregiver may wish to issue supply items to an empty bed so that they can prepare for a patient who has not yet been assigned a room and a bed. Once a patient is assigned to that room, the caregiver will be prompted to confirm that the supplies issued should be issued to the patient. From the Patent List screen as shown in FIG. 21, the caregiver may touch the room where the empty bed is located and to which a patient name has not yet been assigned. A dialog box may appear stating that the room selected does not have a patient assigned, and asking for confirmation that the caregiver wishes to continue If the caregiver wishes to continue they select Yes. Then a Patient Issues screen displays for the empty room (not shown). The caregiver may then scan the items that are being issued to the empty and may alter the quantity as previously described using arrows 35 as shown in FIG. 23. When all of the items have been scanned the caregiver may touch Save Transaction button 36 as shown in FIG. 23. The caregiver is then returned to a Patient List screen.

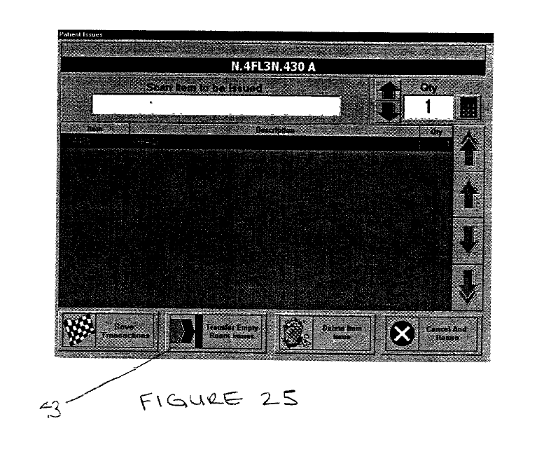

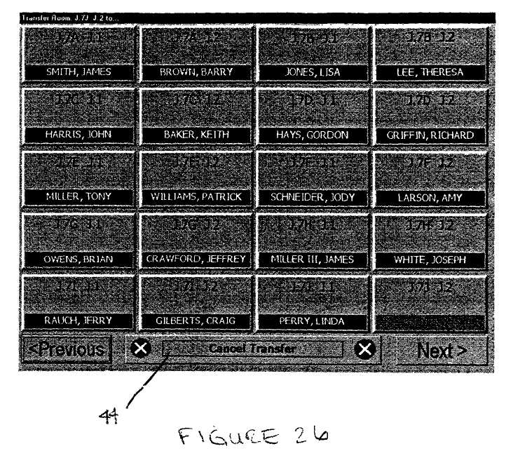

In some instances caregivers may issue supplies to an empty room and then want to transfer those issued items to an assigned bed. The caregiver may wish to transfer the issued items from one empty bed to another. From Patient List screen as shown in FIG. 21, the caregiver should select an empty room from which he would like to transfer charges. A dialog box stating that the room does not have a patient assigned and asking if the caregiver would like to continue appears. The caregiver may select Yes at this point to continue. A Patient Issues screen as shown in FIG. 25 appears which shows all items to be transferred from the empty room. The caregiver taps Transfer Empty Room Issues button. A Transfer Room screen displays as shown in FIG. 26. The caregiver may then select the room to which he would like to transfer the issued items by touching the room number or may select Cancel Transfer 44 button to return to the Patient Issues screen. If the caregiver has selected a room with a patient assigned, a dialog box appears to ask if the caregiver wishes to transfer issues from the empty room to another room. The caregiver may select Yes to transfer or No to cancel. If Yes is selected, the charges transfer and the caregiver is returned to the Patient List screen.

To summarize, the present invention relates to a real-time hand held device that may be used by caregivers to both issue medical/surgical supplies as well as dispense and administer medications. The device communicates with a central database and allows for the tracking, inventory maintenance, billing and restocking of both medical/surgical supplies as well as medications.

While the present invention has been described in connection with exemplary embodiments thereof, those of ordinary skill in the art will recognize that any modifications and variations are possible. Accordingly, the scope of the present invention is intended to be limited only by the following claims and to any equivalents thereof.

What is claimed is:

1. A method of dispensing and administering medications and issuing medical/surgical supplies using a device communicating with a central database comprising the steps of:
(a) inputting information about a patient to the device for whom at least one medication may be dispensed and administered;
(b) dispensing the at least one medication to the patient by inputting information about the at least one medication to the device;
(c) saving the at least one medication to the patient selected;
(d) inputting information about a patient to the device for whom at least one medical/surgical supply may be issued;
(e) issuing the at least one medical/surgical supply to the patient by inputting information about the at least one medical/surgical supply to the device; and
(f) saving the at least one medical/surgical supply to the patient selected.

2. The method as claimed in claim 1 wherein the saving step (c) results in the automatic deduction of the at least one medication from an inventory list saved on the central database.

3. The method as claimed in claim 2 wherein the automatic deduction triggers an automatic reordering of the at least one medication from the central database if the automatic deduction results in the inventory listing for that medication being less than a predetermined level assigned on the database for that medication.

4. The method as claimed in claim 3 wherein the saving step results in the automatic charging of the cost of the at least one medication to an invoice saved on the central database for the patient selected.

5. The method as claimed in claim 4 wherein the saving step (f) results in the automatic deduction of the at least one medical/surgical supply from an inventory list saved on the central database.

6. The method as claimed in claim 5 wherein the automatic deduction triggers an automatic reordering of the at least one medical/surgical supply from the central database if the automatic deduction results in the inventory listing for that medical/surgical supply being less than a predetermined level assigned on the database for that medical/surgical supply.

7. The method as claimed in claim 6 wherein the saving step results in the automatic charging of the cost of the at least one medical/surgical supply to an invoice saved on the central database for the patient selected.

8. The method as claimed in claim 7 additionally comprising the step of logging the user onto the central database by inputting information to the device.

9. The method as claimed in claim 8 wherein the step of logging the user onto the central database is accomplished by scanning a user barcode assigned to the user.

10. The method as claimed in claim 8 wherein the step of logging the user onto the central database is accomplished by typing a user ID and password on a menu of the device.

11. The method as claimed in claim 8 wherein the step of dispensing the at least one medication to the patient is done by scanning bar codes associated with the at least one medication.

12. The method as claimed in claim 8 wherein the step of dispensing the at least one medication to the patient is done by selecting the at least one medication from a menu on the device.

13. The method as claimed in claim 8 wherein the step of issuing the at least one medical/surgical supply to the patient is done by scanning bar codes associated with the at least one medical/surgical supply.

14. The method as claimed in claim 8 wherein the step of issuing the at least one medical/surgical supply to the patient step is done by selecting the at least one medical/surgical supply from a menu on the device.

15. A method of issuing medical/surgical supplies using a device capable of dispensing and administering medication and issuing medical/surgical supplies in communication with a central database, comprising the steps of:
(a) recording the identity of the supply location;
(b) selecting a patient for whom at least one medical/surgical supplies will be issued;
(c) issuing at least one medical/surgical supply; and
(d) saving the at least one medical/surgical supply to the patient selected.

16. The method as claimed in claim 15 wherein the saving step results in the automatic deduction of the at least one medical/surgical supply from an inventory list saved on the central database.

17. The method as claimed in claim 16 wherein the automatic deduction triggers an automatic reordering of the at least one medical/surgical from the central database if the automatic deduction results in the inventory listing for that supply being less than a critical level assigned on the database for that supply.

18. The method as claimed in claim 17 wherein the saving step results in the automatic charging of the cost of the at least one medical/surgical supply to an invoice saved on the central database for the patient selected.

19. The method as claimed in claim 18 additionally comprising the step of logging the user onto the central database through a menu on the device.

20. The method as claimed in claim 19 wherein the step of logging the user onto the central database is accomplished by scanning a user barcode assigned to the user.

21. The method as claimed in claim 19 wherein the step of logging the user onto the central database is accomplished by typing a user ID and password on a menu of the device.

22. The method as claimed in claim 18 wherein the step of recording the identity of the supply location is done by scanning a bar code associated with the supply location.

23. The method as claimed in claim 18 wherein the step of selecting a patient for whom at least one medical/surgical supply will be issued is done by selecting a patient from a menu of the device.

24. The method as claimed in claim 18 wherein the step of issuing at least one medical/surgical supply is done by scanning bar codes associated with the at least one medical/surgical supply to be issued.

25. The method as claimed in claim 18 wherein the step of issuing the at least one medical/surgical supply is done by selecting the at least one medical/surgical supply from a menu on the device.

26. A method of issuing medical/surgical supplies using a device capable of dispensing and administering medication and issuing medical/surgical supplies in communication with a central database, comprising the steps of:
(a) recording the identity of the supply location;
(b) inputting information about a patient to the device for whom at least one medical/surgical supply will be issued;
(c) selecting a supply folder from a menu of the device;
(c) issuing at least one medical/surgical supply; and
(d) saving the at least one medical/surgical supply to the patient selected.

27. The method as claimed in claim 26 wherein the saving step results in the automatic deduction of the at least one medical/surgical supply from an inventory list saved on the central database.

28. The method as claimed in claim 23 wherein the automatic deduction triggers an automatic reordering of the at least one medical/surgical supply from the central database if the automatic deduction results in the inventory listing for that supply being less than a critical level assigned on the database for that supply.

29. The method as claimed in claim 28 wherein the saving step results in the automatic charging of the cost of the at least one medical/surgical supply to an invoice saved on the central database for the patient selected.

30. The method as claimed in claim 29 additionally comprising the step of logging the user onto the central database through a menu on the device.

31. The method as claimed in claim 30 wherein the step of logging the user onto the central database is accomplished by scanning a user barcode assigned to the user.

32. The method as claimed in claim 30 wherein the step of logging the user onto the central database is accomplished by typing a user ID and password on a menu of the device.

33. The method as claimed in claim 30 wherein the step of recording the identity of the supply location is done by scanning a bar code associated with the supply location.

34. The method as claimed in claim 30 wherein the step of inputting information about a patient is done by selecting a patient from a menu of the device.

35. The method as claimed in claim 30 wherein the step of issuing at least one medical/surgical supply is done by scanning bar codes associated with the at least one medical/surgical supply.

36. The method as claimed in claim 30 wherein the step of issuing at least one medical/surgical supply is done by selecting the at least one medical/surgical supply from a menu of the device.

37. A method of dispensing and administering medication and issuing medical/surgical supplies using a device in communication with a central database, comprising the steps of:
(a) selecting a patient from the menu of the device for whom at least one medication will be issued;
(b) selecting a medication folder from a menu of the device for whom at least one medication will be dispensed and administered;
(c) inputting information to the device about the at least one medication to be dispensed and administered;
(d) scanning a patient ID bar code associated with the selected patient;
(e) saving the at least one medication to the patient selected;
(f) recording the identity of a supply location;
(g) selecting a patient from a menu of the device for whom at least one medical/surgical supply will be issued;
(h) selecting a supply folder from a menu of the device;
(i) issuing at least one medical/surgical supply; and
(j) saving the at least one medical/surgical supply to the patient selected.

38. The method as claimed in claim 37 wherein the saving step (e) results in the automatic deduction of the at least one medication from an inventory list saved on the central database.

39. The method as claimed in claim 38 wherein the automatic deduction triggers an automatic reordering of the at least one medication from the central database if the automatic deduction results in the inventory listing for that medication being less than a critical level assigned on the database for that medication.

40. The method as claimed in claim 39 wherein the saving step (e) results in the automatic charging of the cost of the at least one medication to an invoice saved on the central database for the patient selected.

41. The method as claimed in claim 40 wherein the saving step results in the automatic deduction of the at least one medical/surgical supply from an inventory list saved on the central database.

42. The method as claimed in claim 41 wherein the automatic deduction triggers an automatic reordering of the at least one medical/surgical supply from the central database if the automatic deduction results in the inventory listing for that supply being less than a critical level assigned on the database for that supply.

43. The method as claimed in claim 42 wherein the saving step results in the automatic charging of the cost of the at least one medical/surgical supply to an invoice saved on the central database for the patient selected.

44. The method as claimed in claim 43 additionally comprising the step of logging the user onto the central database through a menu on the device.

45. The method as claimed in claim 44 wherein the step of logging the user onto the central database is accomplished by scanning a user barcode assigned to the user.

46. The method as claimed in claim 44 wherein the step of logging the user onto the central database is accomplished by typing a user ID and password on a menu of the device.

47. The method as claimed in claim 43 wherein the step of inputting information to the device about at least one medication to be dispensed and administered is done by scanning bar codes associated with the at least one medication.

48. The method as claimed in claim 43 wherein the step of inputting information to the device about at least one medication to be dispensed and administered is done by selecting the at least one medication from a menu of the device.

49. The method as claimed in claim 43 wherein the step of recording the identity of a supply location is done by scanning with a device a bar code associated with the supply location.

50 The method as claimed in claim 43 wherein the step of issuing at least one medical/surgical supply is done by scanning bar codes associated with the at least one medical/surgical supply.

51. The method as claimed in claim 43 wherein the step of issuing at least one medical/surgical supply is done by scanning bar codes associated with the at least one medical/surgical supply.

52. A device for dispensing and administering medications and issuing medical/supply items comprising:
a barcode scanner for reading information;
a touch screen;
a radio communications unit for transmitting information; and
a processor in communication with said scanner, touch screen and communications unit, said processor being programmed to enable the device to perform the following functions: dispensing medications, administering medications and issuing medical/surgical supplies.

53. An administration system for dispensing and administering medications, issuing medical/surgical supplies, tracking, inventory, maintenance, and billing and restocking medications and medical/surgical supplies comprising:
a central database;
at least one real-time device capable of receiving information associated with mediations and medical/surgical supplies and communicating via radio frequency information;
at least one radio frequency access point for receiving radio frequency communications from the at least one real-time device and communicating the radio frequency communications to the central database;
a decentralized storage location for dispensing medications;
a decentralized storage location for issuing medical/surgical supplies; and
a centralized system, responsive to the central database, for generating restocking packages.
